(19) United States
(12) Patent Application Publication
(10) Pub. No.: US 2006/0069849 A1
(43) Pub. Date: Mar. 30, 2006

(54) Methods and apparatus to update information in a memory

(76) Inventor: John C. Rudelic, Folsom, CA (US)

Correspondence Address: INTEL CORPORATION, P.O. BOX 5326, SANTA CLARA, CA, 95056-5326, US

(21) Appl. No.: 10/957,439

(22) Filed: Sep. 30, 2004

(51) Int. Cl. G06F 12/08

(52) U.S. Cl. 711/103; 711/203

(57) ABSTRACT

A method and apparatus to update information in a memory is provided. The apparatus may be a nonvolatile memory that may include a control circuit to swap the physical addresses of a first block and a second block of the nonvolatile memory as part of an operation to update information stored in the first block, wherein the control circuit is internal to the nonvolatile memory. Other embodiments are described and claimed.

### BACKGROUND

Nonvolatile memories such as, for example, a flash electrically erasable programmable read-only memory (“flash EEPROM” or “flash memory”) may retain their data until the memory is erased. Flash memory may be arranged as blocks of single transistor memory cells that may include a floating gate to store information. Although a flash memory is rewritable, the memory cells may not be re-programmed unless they have first been erased.

Further, the flash memory cells may only be erasable in blocks. Thus in order to erase one cell, an entire block of cells may have to be erased. Erasing a block of flash memory may be a relatively time consuming process. For example, in some flash memories, the erasing of a block of memory may take approximately one second. Updating information stored in a memory may be performed in many different ways, and in some memories, may include one or more erase operations.

### BRIEF DESCRIPTION OF THE DRAWINGS

FIG. 1 is a block diagram illustrating a portion of a computing system in accordance with an embodiment of the present invention;

FIG. 2 is a flow diagram illustrating a method in accordance with an embodiment of the present invention; and

FIG. 3 is a block diagram illustrating a wireless device in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “include” and “comprise,” along with their derivatives, may be used, and are intended to be treated as synonyms for each other. In addition, in the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Further, “coupled” may mean that two or more elements are indirectly joined together, for example, via one or more other elements.

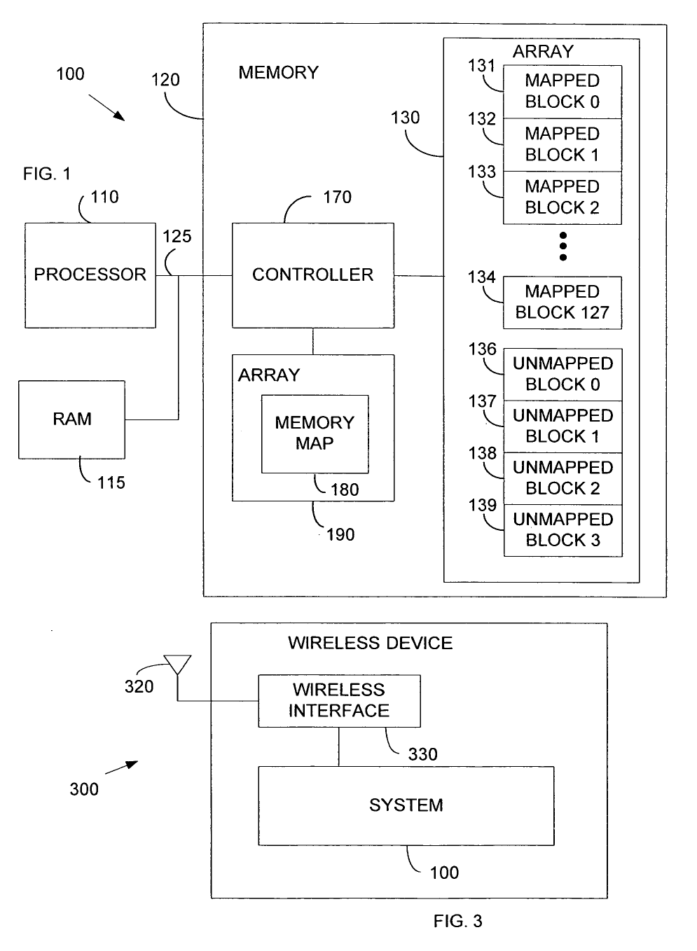

FIG. 1 is a block diagram illustrating a portion of a computing system 100 in accordance with an embodiment of the present invention. Although the scope of the present invention is not limited in this respect, system 100 may be used in a personal digital assistant (PDA), a wireless telephone (for example, cordless or cellular phone), a pager, a digital music player, a laptop or desktop computer, a set-top box, a printer, etc.

System 100 may include a processor 110 and a nonvolatile memory 120 coupled to processor 110 via a bus 125. In addition, system 100 may include a random access memory (RAM) 115 coupled to processor 110 and to nonvolatile memory 120 via bus 125. Bus 125 may include one or more busses and may be a single 16-bit bus in one embodiment. Although not shown, system 100 may include other components such as, for example, more processors, input/output (I/O) devices, memory devices, or storage devices. However, for simplicity these additional components have not been shown.

In one embodiment, processor 110 may be a discrete component or device and may be external to nonvolatile memory 120. Processor 110 may include digital logic to execute software instructions and may also be referred to as a central processing unit (CPU). Software instructions executed by processor 110 may be stored in nonvolatile memory 120 and may also be referred to as code.

One example of software executed by processor 110 includes memory management software that may be used to manage the storage of code, data, and files in nonvolatile memory 120. The memory management software may include data and code update software and may also be referred to in various embodiments as code management software, data management software, file management software, file system software, file system driver software, file system management software, flash file management software, or a flash media manager.

Although not shown, processor 110 may include a CPU core that may comprise an arithmetic-logic unit (ALU) and registers. In one embodiment, processor 110 may be an XScale® microprocessor available from Intel® Corporation (both XScale and Intel are a registered trademarks of Intel Corporation). The XScale® microprocessor may be a 32-bit microprocessor that may include an ARM based core, although the scope of the present invention is not limited in this respect. Embodiments of the present invention may be used with other microprocessors having cores other than an ARM based core, for example, a MIPS based core, x86 based core, etc. Further, embodiments of the present invention may be used with 4-bit, 8-bit, or 64-bit microprocessors.

Although the scope of the present invention is not limited in this respect, in some embodiments, RAM 115 may be a volatile memory such as, for example, a static random access memory (SRAM) or a dynamic random access memory (DRAM). In some embodiments, RAM 115 may have a relatively faster access time compared to nonvolatile memory 120 and may serve as a cache memory to cache information from nonvolatile memory 120.

In some embodiments, nonvolatile memory 120 may be a NAND or NOR type of flash memory, and may be a single bit per cell memory capable of storing one bit of information per memory cell or multiple bits per cell memory capable of storing more than one bit of information per memory cell.

Although nonvolatile memory 120 is discussed as a flash memory, this is not a limitation of the present invention. In other embodiments, nonvolatile memory 120 may be another type of memory capable of storing data when power is removed from the memory. For example, nonvolatile memory 120 may be a ferroelectric random access memory (FRAM), a magnetic random access memory (MRAM), or any other nonvolatile device capable of storing code and/or data.

In various embodiments, the components of system 100 may be integrated together on a single silicon die, or in alternate embodiments the components may be discrete components. In yet another embodiment, processor 110 and RAM 115 may be integrated together and nonvolatile memory 120 may be a discrete, external (“off-chip”) component.

The term “information” may be used to refer to data, instructions, or code. Information may be stored in the nonvolatile memory either contiguously or in fragments. Examples of data may include a serial number of a device or encryption keys. If system 100 is used in a wireless telephone, examples of data may include ring tone data or telephone number data. Examples of code may include a software application (for example, a downloadable computer game), an operating system (O/S), a java applet, or libraries used by the operating system.

Nonvolatile memory 120 may store both code and data and may store code in one partition of memory 120 and may store data in another partition of memory 120. Each partition of nonvolatile memory 120 may comprise a plurality of blocks of memory, wherein each block includes a plurality of memory cells capable of storing at least one bit of information. The partition of nonvolatile memory 120 where data is stored may include one or more blocks and may be referred to as the data volume of nonvolatile memory 120. The partition of nonvolatile memory 120 where code is stored may include one or more blocks and may be referred to as the code volume of nonvolatile memory 120. In one embodiment, data may be stored in memory 120 in fragments and code may be stored in memory 120 contiguously.

A code manager may be used to store and manage code in the code volume of nonvolatile memory 120. The code manager may be code management software that is stored in nonvolatile memory 120 and may be executed by processor 110. The code manager may be used to alter code in nonvolatile memory 120. For example, the code manager may be used to assist in the replacing or updating of code stored in nonvolatile memory 120. In other words, the code manager may be used to add code to, or delete code from nonvolatile memory 120.

In some applications, the code stored in nonvolatile memory 120 may be dynamic or alterable. For example, in cell phones, code stored in the nonvolatile memory of the cell phone may be updated or replaced by a user of the phone or by using an over-the-air code update operation. The code manager may be used to perform the updating or replacing of code.

The code manager may store code contiguously in array 130 so that it can be directly accessed from nonvolatile memory 120, that is, fetched and executed from nonvolatile memory 120 using processor 110 without the intermediate step of loading the code to a volatile random access memory (RAM) such as, for example, RAM 115. This is sometimes referred to as execute-in-place (XIP) in some flash memories. By storing code contiguously in nonvolatile memory 120, pointer access may be provided so that processor 110 may directly access code stored in array 130.

In one embodiment, nonvolatile memory 120 may include an array 130 that is structured into one or more memory blocks. Although the scope of the present invention is not limited in this respect, in some embodiments, array 130 may include 132 blocks of memory, wherein a block of memory may range in size from about 16 kilobytes (Kbytes) to about one megabyte (Mbyte).

In the example, wherein array 130 includes 132 blocks, 128 blocks, labeled as blocks 131-134, may be assigned or mapped to physical addresses and may be referred to as mapped blocks. The physical addresses may be used by code such as, for example, memory management software executing or running on a component external to memory 120 such as, for example, processor 110, to access information stored in the memory blocks of memory 120. In some embodiments, the components and/or software external to nonvolatile memory 120 may be able to access information using the physical addresses 0x000000 to 0x79FFFF. This address range may be referred to as the addressable space of nonvolatile memory 120.

Although the scope of the present invention is not limited in the respect, as an example, each memory block of array 130 may be capable of storing about 64 kilobytes of information, and the information stored in a block may be byte accessible. In other words, each block of memory may be mapped to a specified range of physical addresses and information may be accessed at a byte level, that is, on a byte-by-byte basis using the physical addresses. In this embodiment, block 131 (labeled “MAPPED BLOCK 0”) may be mapped so that the first byte of information stored in block 131 may be accessed using physical address 0x000000 and the last byte of information stored in block 131 may be accessed using physical address 0X00FFFF. Accessing a byte of information in memory 120 may refer to reading a byte of information from, or writing a byte of information to a block in memory 120.

Continuing with this example, block 132 (labeled “MAPPED BLOCK 1”) may be mapped so that the first byte of information stored in block 132 may be accessed using physical address 0x010000 and the last byte of information stored in block 132 may be accessed using physical address 0x01FFFF. Block 133 (labeled “MAPPED BLOCK 2”) may be mapped so that the first byte of information stored in block 133 may be accessed using physical address 0x020000 and the last byte of information stored in block 132 may be accessed using physical address 0x02FFFF. Finally, the last of the mapped 128 blocks, that is, block 134 (labeled “MAPPED BLOCK 127”) may be mapped so that the first byte of information stored in block 134 may be accessed using physical address 0x790000 and the last byte of information stored in block 134 may be accessed using physical address 0x79FFFF.

In the embodiments wherein memory 120 is a flash memory, memory 120 may only be erasable at a block level, that is, on a block-by-block basis, as opposed to a bit level or byte level. In some embodiments, memory management software that is running on processor 110 may initiate an erase operation to a selected block of array 130. The erase operation may include sending an erase command over bus 125 to data pins (not shown) of memory 120 and an address within the address range mapped to the targeted erase block to address pins (not shown) of memory 120. Nonvolatile memory 120 may decode the erase command and address from processor 110 using, for example, controller 170 of memory 120, and perform the erasing of the targeted block.

A memory map 180 may be stored in memory 120. For example, memory map 180 may be stored in an array 190 of memory 120 and may be used to store the mapping information for nonvolatile memory 120. The mapping information stored in memory map 180 may include information about the mapping of the mapped blocks 131-134 to physical addresses. In some embodiments, array 190 may include one or more nonvolatile memory cells so that the memory map may be stored in a nonvolatile storage area of memory 120. Further, array 190 may be smaller in size than array 130 and may be referred to as a “mini array.”

Nonvolatile memory 120 may further include unmapped blocks 136-139 respectively labeled “UNMAPPED BLOCK 0,” “UNMAPPED BLOCK 1,” “UNMAPPED BLOCK 2,” and “UNMAPPED BLOCK 3.” These blocks may be the same size as mapped blocks 131-134 and may be used for various operations such as, for example, erase operations as described below. Unmapped blocks 136-139 are not mapped to any physical addresses in the addressable space of memory 120, and therefore, may not be accessible by components or code external to memory 120.

Although array 130 is shown as having 132 blocks of memory, this is not a limitation of the present invention. In other embodiments, memory 120 may include more than or less than 132 blocks.

Nonvolatile memory 120 may also include internal resources to perform at least part of an update operation to update or replace information stored in memory 120. The internal resources of memory 120 that may be used to implement an update operation may include hardware and optionally code such as, for example, software or microcode. Microcode may also be referred to as firmware.

In one embodiment, nonvolatile memory 120 may include a controller 170 that may include circuitry such as, for example, digital logic, and may optionally execute code that may be used to perform functions for an update operation. In addition, controller 170 may also be used to perform various control activities for memory 120. For example, in addition to update operations, controller 170 may also be used to perform writing, erasing, and reading operations in memory 120 in response to write, erase, or read commands from a processor external to memory 120 such as, for example, processor 110.

Controller 170 may also be referred to as a control circuit and in various embodiments may be a state machine, an application specific integrated circuit (ASIC), or a processor such as, for example, a microprocessor, a co-processor, or a microcontroller. In one embodiment, controller 170 may be an 8-bit microcontroller, although the scope of the present invention is not limited in this respect. In other embodiments, controller 170 may be a 4-bit, 32-bit, or 64-bit microcontroller or processor.

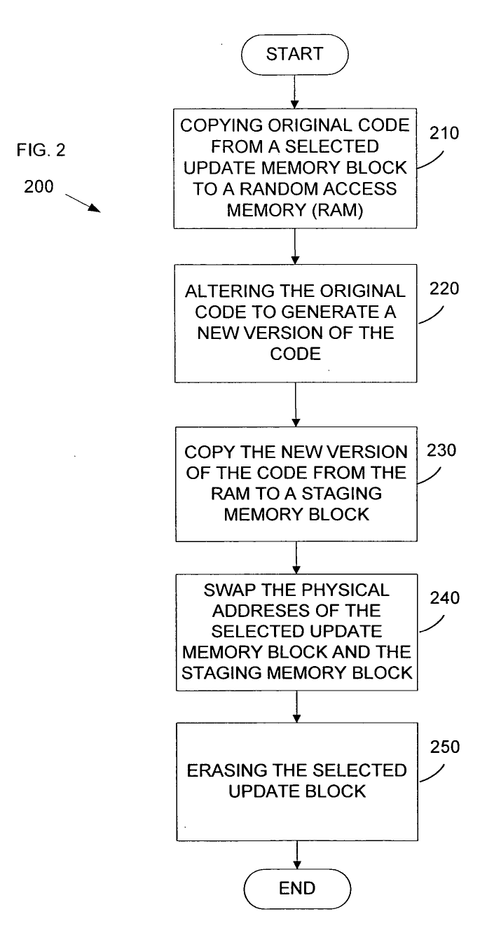

Turning to FIG. 2, a flow diagram is shown illustrating a method 200 to perform an update operation in nonvolatile memory 120 in accordance with an embodiment of the present invention. This method will be described with reference to system 100 of FIG. 1. Although the individual steps or acts of method 200 are illustrated and described below as separate acts, one or more of the individual acts may be performed concurrently and the scope of the present invention is not limited to performing these acts in the order illustrated.

As will be discussed below, in some embodiments, steps 210, 220, and 230 of method 200 may be performed by code such as, for example, memory management software that is executed using processor 110. For example, method 200 may be used to update code stored in one or more blocks of memory 120. In this example, code update software that is executed using processor 110 may be used to perform steps 210, 220, and 230 of method 200.

In some embodiments, steps 240 and 250 may be performed using internal resources of memory 120. For example, steps 240 and 250 may be performed using controller 170, which is internal to nonvolatile memory 120. In addition to hardware internal to nonvolatile memory 120, software or microcode within nonvolatile memory 120 may also be used to perform the actions of blocks 240 and 250. Accordingly, in various embodiments, steps 240 and 250 may be performed using only internal resources of nonvolatile memory 120. For example, in some embodiments, only hardware internal to nonvolatile memory 120 such as, for example, a control circuit may be used to perform steps 240 and 250. In other embodiments, hardware internal to nonvolatile memory 120 such as, for example, controller 170, and microcode or software executed by controller 170 may be used to perform steps 240 and 250.

Method 200 may begin with copying original information stored in a selected update memory block, for example, block 131, to RAM 115 (flow diagram block 210 of FIG. 2). This step of copying the original information stored in memory block 131 may be in response to, or as part of a code update operation to update original code stored in block 131 with new or updated code. Although the scope of the present invention is not limited in this respect, the code update operation may be initiated by a user of system 100 or be part of an over-the-air update operation. In an alternate embodiment, a memory buffer internal to memory 120 may be used rather than using RAM 115.

Code update software being executed by processor 110 may initiate a read operation that may include sending a read request or read command to memory 120 to read information from the selected block to be updated, that is, block 131. The read operation may include one or more read operations that may include copying all the bytes of information stored in block 131 to RAM 115. For example, all the bytes stored at physical addresses 0x000000 to 0X00FFFF may be read and copied into RAM 115.

Next, the code update software being executed by processor 110 may alter at least one bit of the original code to update the original code to new or updated code while the code is stored in RAM 115 (flow diagram block 220 of FIG. 2). For example, an over-the-air code update may just send one or more bytes to be updated and not an entire new version of the code. In this example, the one or more bytes of new code that is received from the over-the-air transmission may be overlaid on the original code in RAM 115 to generate new, updated version of the code that exists in RAM 115. In other words, the one or more bytes of new code may replace corresponding bytes in the original code.

The updated version of the code may be copied from RAM 115 to a block other than block 131 (flow diagram block 230 of FIG. 2) of memory 120. For example, the updated code may be copied or written to an erased block such as, for example, block 134, which may be previously erased using an erase operation. In this example, block 134 may be referred to as a staging memory block. Code update software being executed by processor 110 may initiate a write operation that may include sending one or more write commands to memory 120 to write the updated code from RAM 115 to block 134. In other words, the code update software being executed by processor 110 may initiate the writing of the updated code to physical addresses 0x790000 through 0x79FFFF.

After the updated code is copied into block 134, a swap operation may be performed to swap the physical addresses of block 131 and block 134 (flow diagram block 240 of FIG. 2). This swap operation may include using internal resources of memory 120 such as, for example, controller 170 and optionally microcode in memory 120, to alter memory map 180 so that block 131 is mapped to the physical address range of 0x790000 to 0x79FFFF and so that block 134 is mapped to the physical address range of 0x000000 to 0x00FFFF. At this point in time, the new version of the code is located in block 134 and may be accessed using addresses 0x000000 to 0x00FFFF.

After the swap operation is complete, method 200 may include erasing block 131 (flow diagram block 240 of FIG. 2). In some embodiments, this may include mapping an erased unmapped block, for example block 136, to the physical address range of 0x790000 to 0x79FFFF and unmapping block 131 so that block 131 is not mapped to any physical addresses. Unmapping block 131 may result in block 131 not being accessible by external components or code executing on a processor external to nonvolatile memory 120. As may be appreciated, unmapped blocks 136-139 may be previously erased so as to provide a pool of erased unmapped blocks.

Allocating a spare erased block from the pool of erased unmapped blocks 136 139 to perform an erase operation may be referred to as a dynamic block swap (DBS) operation or a zero second erase time (ZSET) operation. The term ZSET may be used since the erase operation may be performed internal to memory 120 using a background operation, and the erase may effectively appear to take much less than one second, for example, about 100 microseconds, to a user of system 100.

By swapping the physical addresses of blocks 131 and 134 as part of the code update operation to update code stored in block 131, this may reduce the amount of time to update code as perceived by components or code external to memory 120. In some flash memories, the erasing of a block of memory may take about one second. By using a swapping operation to swap physical addresses assigned to memory blocks as part of an operation to update information in a block of memory 120, this may improve performance of a system since the system may proceed to execute code stored in memory 120 immediately after the swap operation is completed. In some embodiments, the time to complete steps 210, 220, 230, and 240 may be about 100 microseconds or less. Accordingly, in these systems, the time between initiating a code update operation to when the new code is ready to be executed or accessed from memory 120 may be about 100 microseconds or less. In other systems that do not use a swapping operation as disclosed herein, the time between initiating a code update operation to when the new code is ready to be executed or accessed from memory 120 may be about second.

If the code to be updated spans more than one block, then steps 210, 220, 230, 240 and 250 illustrated in FIG. 2 may be repeated for each memory block that includes information to be updated. Although method 200 has been described in some embodiments for a code update operation, this is not a limitation of the present invention. In other embodiments, method 200 may also be used as part of an operation to update or replace data stored in memory 120.

Turning to FIG. 3, shown is a block diagram illustrating a wireless device 300 in accordance with an embodiment of the present invention. In one embodiment, wireless device 300 may use the methods discussed above and may include computing system 100 (FIG. 1).

As is shown in FIG. 3, wireless device 300 may include an antenna 320 coupled to a processor of system 100, for example, processor 110, via a wireless interface 330. In various embodiments, antenna 320 may be a dipole antenna, helical antenna or another antenna adapted to wirelessly communicate information. Wireless interface 330 may be adapted to process radio frequency (RF) and baseband signals using wireless protocols and may include a wireless transceiver.

Wireless device 300 may be a personal digital assistant (PDA), a laptop or portable computer with wireless capability, a web tablet, a wireless telephone (for example, cordless or cellular phone), a pager, an instant messaging device, a digital music player, a digital camera, or other devices that may be adapted to transmit and/or receive information wirelessly. Wireless device 300 may be used in any of the following systems: a wireless personal area network (WPAN) system, a wireless local area network (WLAN) system, a wireless metropolitan area network (WMAN) system, or a wireless wide area network (WWAN) system such as, for example, a cellular system.

An example of a WLAN system includes a system substantially based on an Industrial Electrical and Electronics Engineers (IEEE) 802.11 standard. An example of a WMAN system includes a system substantially based on an Industrial Electrical and Electronics Engineers (IEEE) 802.16 standard. An example of a WPAN system includes a system substantially based on the Bluetooth™ standard (Bluetooth is a registered trademark of the Bluetooth Special Interest Group). Another example of a WPAN system includes a system substantially based on an Industrial Electrical and Electronics Engineers (IEEE) 802.15 standard such as, for example, the IEEE 802.15.3a specification using ultrawideband (UWB) technology.

Examples of cellular systems include: Code Division Multiple Access (CDMA) cellular radiotelephone communication systems, Global System for Mobile Communications (GSM) cellular radiotelephone systems, Enhanced data for GSM Evolution (EDGE) systems, North American Digital Cellular (NADC) cellular radiotelephone systems, Time Division Multiple Access (TDMA) systems, Extended-TDMA (E-TDMA) cellular radiotelephone systems, GPRS, third generation (3G) systems like Wide-band CDMA (WCDMA), CDMA-2000, Universal Mobile Telecommunications System (UMTS), or the like.

Although computing system 100 is illustrated as being used in a wireless device in one embodiment, this is not a limitation of the present invention. In alternate embodiments system 100 may be used in non-wireless devices such as, for example, a server, a desktop, or an embedded device not adapted to wirelessly communicate information.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method to update information stored in a first block of a nonvolatile memory, comprising:
swapping the physical addresses of the first block and a second block of the nonvolatile memory as part of an operation to update the information stored in the first block.

2. The method of claim 1, wherein swapping comprises swapping the physical addresses of the first block and the second block of the nonvolatile memory as part of an operation to update code stored in the first block.

3. The method of claim 1, wherein the swapping is performed using a control circuit internal to the flash memory.

4. The method of claim 1, wherein the swapping is performed using a controller internal to the nonvolatile memory and using microcode internal to the nonvolatile memory.

5. The method of claim 1, wherein prior to the swapping, the first block is mapped to a first physical address to access information stored in the first block and the second block is mapped to a second physical address to access information stored in the second block and wherein swapping includes mapping the second block to the first physical address and mapping the first block to the second physical address.

6. The method of claim 1,
wherein swapping comprises updating a memory map in the nonvolatile memory;
wherein the updating is performed using a controller internal to the nonvolatile memory;
wherein the memory map includes the mapping of a plurality of blocks of the nonvolatile memory to physical addresses;
wherein the plurality of blocks includes the first block and the second block; and
wherein the physical addresses are used by code executing on a component external to the nonvolatile memory to access information stored in the plurality of blocks of the nonvolatile memory.

7. The method of claim 1, further comprising:
copying original information stored in the first block to a volatile memory;
altering at least one bit of the original information to update the original information to updated information while the information is stored in the volatile memory; and
copying the updated information to the second block from the volatile memory.

8. The method of claim 7, wherein the copying the original information, the altering, and the copying the updated information are performed by software executing on a processor external to the nonvolatile memory.

9. The method of claim 7,
wherein prior to the swapping, a first plurality of physical addresses is assigned to the first block to access information stored in the first block and a second plurality of physical addresses is assigned to the second block to access information stored in the second block and wherein swapping includes swapping the physical addresses of the first block and the second block so that the first plurality of physical addresses is assigned to the second block and the second plurality of physical addresses is assigned to the first block;
wherein the copying the original information occurs prior to the swapping and comprises reading the original information stored in the first block of memory using a first physical address of the first plurality of physical addresses; and
wherein the copying the updated information occurs prior to the swapping and comprises writing the updated information to the second block of the nonvolatile memory using a first physical address of the second plurality of physical addresses.

10. The method of claim 7, further comprising erasing the first block after the swapping and after the copying the updated information to the second block.

11. The method of claim 10, wherein the nonvolatile memory includes at least one unmapped block of memory and wherein erasing the first block includes mapping the unmapped block to the second plurality of physical addresses and unmapping the first block so that the first block is not accessible by code executing on components external to the nonvolatile memory.

12. The method of claim 10,
wherein prior to the swapping, the first block is mapped to a first physical address to access information stored in the first block and the second block is mapped to a second physical address to access information stored in the second block and wherein swapping includes swapping the physical addresses of the first block and the second block so that the first block is mapped to the second physical address and the second block is mapped to the first physical address,
wherein the copying the original information occurs prior to the swapping and comprises reading the original information stored in the first block of memory using the first physical address;
wherein the copying the updated information occurs prior to the swapping and comprises writing the updated information to the second block of the nonvolatile memory using the second physical address; and
wherein the nonvolatile memory includes at least one unmapped block and wherein the erasing the first block includes mapping the unmapped block to the second physical address and unmapping the first block so that the first block is not accessible by code executing on components external to the nonvolatile memory.

13. A nonvolatile memory having a first block and a second block, comprising:
a control circuit to swap the physical addresses of the first block and the second block as part of an operation to update information stored in the first block, wherein the control circuit is internal to the nonvolatile memory.

14. The nonvolatile memory of claim 13, wherein the control circuit includes circuitry to map the first block to a first physical address to access information stored in the first block and to map the second block to a second physical address to access information stored in the second block.

15. The nonvolatile memory of claim 14, wherein the control circuit maps the second block to the first physical address and maps the first block to the second physical address to swap the physical addresses of the first block and the second block.

16. The nonvolatile memory of claim 15, wherein the control circuit includes circuitry to erase the first block after the control circuit swaps the physical addresses of the first block and the second block.

17. The nonvolatile memory of claim of claim 16, wherein the nonvolatile memory includes at least one unmapped block and wherein erasing the first block includes mapping the unmapped block to the second physical address and unmapping the first block so that the first block is not accessible by code executed using a component external to the nonvolatile memory.

18. The nonvolatile memory of claim 13,
wherein the control circuit updates a memory map to swap the physical addresses of the first block and the second block;
wherein the memory map is stored in the nonvolatile memory;
wherein the memory map includes the information about the mapping of the first and second blocks of the nonvolatile memory to physical addresses of the nonvolatile memory; and
wherein the physical addresses are used by code that is executed on a processor external to the nonvolatile memory to access information stored in the nonvolatile memory.

19. The nonvolatile memory of claim 13, wherein the first of block of the nonvolatile memory stores a plurality of bytes of information and wherein each byte of the plurality of bytes of information may be accessed using one of a plurality of physical addresses.

20. The nonvolatile memory of claim 13, wherein the nonvolatile memory includes a plurality of blocks including the first and second blocks, and wherein each block of the plurality of blocks includes a plurality of nonvolatile memory cells.

21. The nonvolatile memory of claim 13, wherein the nonvolatile memory includes at least about 128 memory blocks including the first and second blocks and wherein each memory block of the plurality of memory blocks is at least about 16 kilobytes in size.

22. The nonvolatile memory of claim 13, wherein the nonvolatile memory includes a plurality of blocks including the first and second blocks, and wherein the nonvolatile memory is erasable only at a block level.

23. The nonvolatile memory of claim 13, wherein the nonvolatile memory is a flash electrically erasable programmable read-only memory (EEPROM).

24. The nonvolatile memory of claim 23, wherein the nonvolatile memory is a single bit per cell nonvolatile flash EEPROM capable of storing one bit of information per memory cell.

25. The nonvolatile memory of claim 23, wherein the nonvolatile memory is capable of storing more than one bit of information per memory cell.

26. The nonvolatile memory of claim 13, wherein the nonvolatile memory is a ferroelectric random access memory (FRAM) or a magnetic random access memory (MRAM).

27. A system, comprising:
a processor;
an antenna coupled to the processor; and
a flash electrically erasable programmable read-only memory (EEPROM) coupled to the processor, wherein the processor is external to the flash EEPROM and wherein the flash EEPROM comprises a control circuit to swap the physical addresses of the first block and the second block as part of an operation to update information stored in the first block, wherein the control circuit is internal to the nonvolatile memory.

28. The system of claim 27, wherein the system is a wireless phone.

29. The system of claim 27, wherein the control circuit includes circuitry to map the first block to a first physical address to access information stored in the first block and to map the second block to a second physical address to access information stored in the second block.

30. The system of claim 29, wherein the control circuit maps the second block to the first physical address and maps the first block to the second physical address to swap the physical addresses of the first block and the second block.

31. The system of claim 29, further comprising a volatile memory coupled to the flash EEPROM and the processor, wherein the volatile memory is external to the flash EEPROM.

32. The system of claim 27, wherein the control circuit includes circuitry to erase the first block after the control circuit swaps the physical addresses of the first block and the second block.

33. The system of claim 32, wherein the flash EEPROM includes at least one unmapped block and wherein erasing the first block includes mapping the unmapped block to the second physical address and unmapping the first block so that the first block is not accessible by code executed using a component external to the flash EEPROM.
